(19) United States
(12) Patent Application Publication
(10) Pub. No.: US 2003/0003337 A1
(43) Pub. Date: Jan. 2, 2003

(54) Fuel cell power system

(76) Inventors: John P. Scartozzi, Spokane, WA (US); Peter D. DeVries, Tekoa, WA (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 09/996,880

(22) Filed: Nov. 30, 2001

Related U.S. Application Data
(63) Continuation-in-part of application No. 09/873,139, filed on Jun. 1, 2001.

(51) Int. Cl. H01M 8/04

(52) U.S. Cl. 429/26; 429/38

(57) ABSTRACT

A fuel cell power system is described and which includes a plurality of modules each enclosing a fuel cell stack and a cooling assembly, and wherein at least one of the modules can be easily removed from the fuel cell power system, by hand, while the remaining modules continue to operate.

### RELATED PATENT DATA

This is a continuation-in-part of U.S. patent application Ser. No. 09/873,139 filed on Jun. 1, 2001, and which is incorporated by reference herein.

### TECHNICAL FIELD

The present invention relates to a fuel cell power system, and more specifically to a fuel cell power system which employs fuel cell power modules which enclose fuel cell stacks

### BACKGROUND OF THE INVENTION

The fuel cell is an electrochemical device which reacts hydrogen; and oxygen, which is usually supplied from the air, to produce electricity and water. Heretofore, fuel cells have utilized a wide range of fuels, including, but not limited to, natural gas and coal derived synthetic fuels, and which are subsequently converted to electric power. The basic process is well understood, highly efficient, and for those fuel cells fueled directly by hydrogen, pollution free. Further, since fuel cells can be assembled into stacks of varying sizes, power systems have been developed to produce a wide range of output levels to satisfy numerous applications.

Although the fundamental electrochemical processes involved in all fuel cells are well understood, engineering solutions have proved elusive for making fuel cell stack arrangements commercially feasible, and economical. In the case of fuel cell slacks which use proton exchange membranes, reliability has not been the driving concern to date, but rather the principal concern has been the installed cost per watt of generation capacity. With respect to these types of fuel cells, in order to lower the cost per watt, much attention has been placed on increasing power output. In the elusive search to increase power output, much research and development activity has been spent on additional, and often sophisticated balance-of-plant measures. These previous balance-of-plant measures or systems have been deemed necessary to optimize and maintain the high fuel cell power outputs desired. As a direct result of these additional balance-of-plant measures these fuel cell systems do not readily scale down to low generation capacities. Consequently, the installed cost; efficiency; reliability and maintenance expenses are all adversely affected in low generation applications. Yet further, since proton exchange membrane fuel cells produce a useful voltage of only about 0.5 to about 0.7 volts D.C. under a load, practical fuel cell plants have been built from multiple cells stacked together such that they are electrically connected in series. In order to reduce the number of parts and to minimize costs, rigid supporting/conducting separator plates, often fabricated from graphite or special metals have been utilized. This is often described as bipolar construction. Heretofore, practical stacks have consisted of 20 or more cells in order to produce the direct current voltages necessary for efficient inverting to alternating current.

While the economic advantages of stack designs using bipolar plate construction are compelling, this construction does have numerous disadvantages which have detracted from its usefulness. For example, if the voltage or performance of a single cell in a stack begins to decline or fails, the entire stack, which is held together in compression with tie bolts, must be taken out of service, disassembled and repaired. In traditional fuel cell stack designs, the fuel and oxygen are directed by means of internal manifolds to the proper electrodes. Cooling for the stack is provided either by the reactants; natural convection; radiation; and possibly supplemental cooling plates. Also included in the prior art stack designs are cell-to-cell seals; insulation; piping and various instrumentation and sensors for use in monitoring the fuel cell performance. As should be apparent, if malfunction or a maintenance problem occurs with a fuel cell stack design, there is no ready solution except to take the fuel cell stack off-line and return it to the factory for repair or replacement as necessary. In view of the difficulties encountered in removing fuel cell stacks of this type for repair or replacement, such designs have not become practical from a commercial sense, at least as applied to low generation applications.

A new fuel cell power system utilizing fuel cell stack technology which avoids the perceived shortcomings of the prior art is the subject matter of the present invention.

### SUMMARY OF THE INVENTION

One aspect of the present invention is to provide a fuel cell power system which includes a plurality of fuel cell power modules, each enclosing a fuel cell stack, and a cooling assembly, and wherein at least one of the modules can be removed from the fuel cell power system, by hand, while the remaining modules continue to operate.

Another aspect of the present invention is to provide a fuel cell power system which includes an enclosure defining an internal space; a subrack or module receiving assembly moveably mounted on the enclosure and operable to be received in the internal space defined by the enclosure; and a plurality of fuel cell power modules each enclosing a fuel cell stack, and wherein the modules operably mate with the subrack or module receiving assembly, and can be removed from the subrack while the remaining modules continue to operate.

Yet another aspect of the present invention relates to a fuel cell power system which includes a module receiving assembly; a module frame having an internal cavity, and which slideably matingly cooperates both electrically and in fluid flowing relation with the module receiving assembly; a fuel cell stack mounted in the internal cavity; a controller which is electrically coupled to the fuel cell stack; and a cooling assembly borne by the module frame, and which directs a flow of air from ambient through the fuel cell stack, and which returns the air to ambient to facilitate the dissipation of heat generated while the fuel cell stack is operational.

Moreover, another aspect of the present invention relates to a fuel cell power system which includes a module receiving assembly; a module frame having opposite front and rear walls which define, in part, an internal cavity, and which is further defined by a major axis extending between the opposite front and rear walls, and which slideably matingly cooperates both electrically and in fluid flowing relation with the module receiving assembly; a fuel cell stack mounted in the internal cavity; a controller which is electrically coupled to the fuel cell stack; and a cooling assembly borne by the module frame and coupled to the controller, and which dissipates heat energy generated by the fuel cell stack while it is in operation; and wherein the cooling assembly further includes an air plenum which extends substantially between the front and rear walls, and which is coupled in fluid flowing relation to ambient, and which directs a flow of air from ambient, along the air plenum, through the fuel cell stack, and back to ambient; and a fan mounted in the internal cavity of the module frame, and which is operably coupled to the air plenum to facilitate movement of the air along the air plenum.

Still another aspect of the present invention relates to a fuel cell power system which includes a module receiving assembly; a module frame defining an internal cavity, and which has opposite first and second ends; a fuel cell stack mounted in the internal cavity, and which slideably matingly cooperates both electrically and in fluid flowing relation with the module receiving assembly; a controller which is electrically coupled to the fuel cell stack; and a cooling assembly which directs a flow of cooling fluid along a substantially non-linear path of travel between the first and second ends of the module frame, and through the fuel cell stack to dissipate heat energy generated by the fuel cell in operation.

### DETAILED DESCRIPTION OF THE DRAWINGS

The accompanying drawings serve to explain the principles of the present invention.

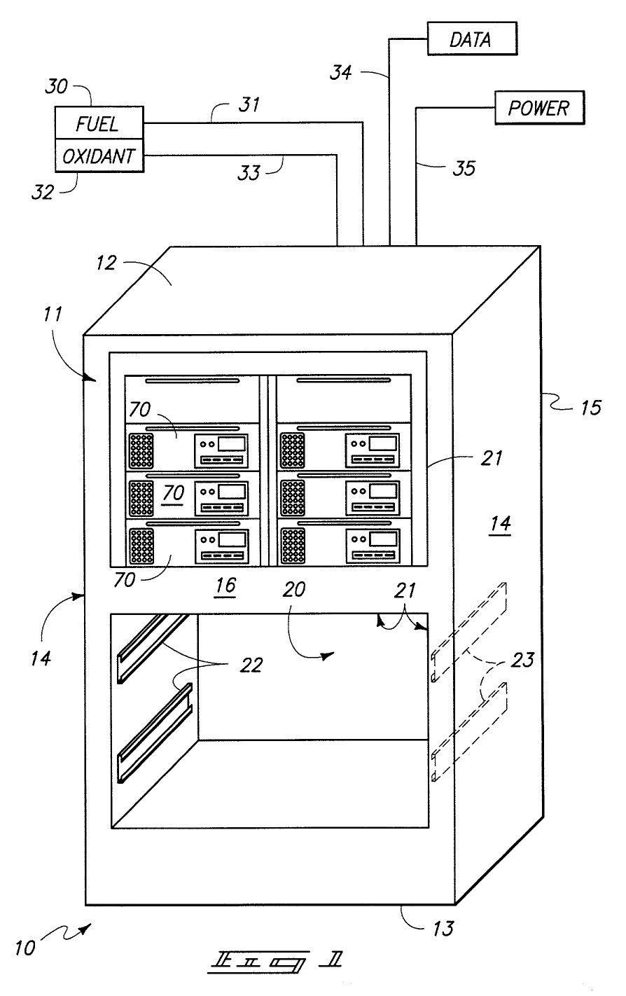

FIG. 1 is a front elevation view of a fuel cell power system of the present invention.

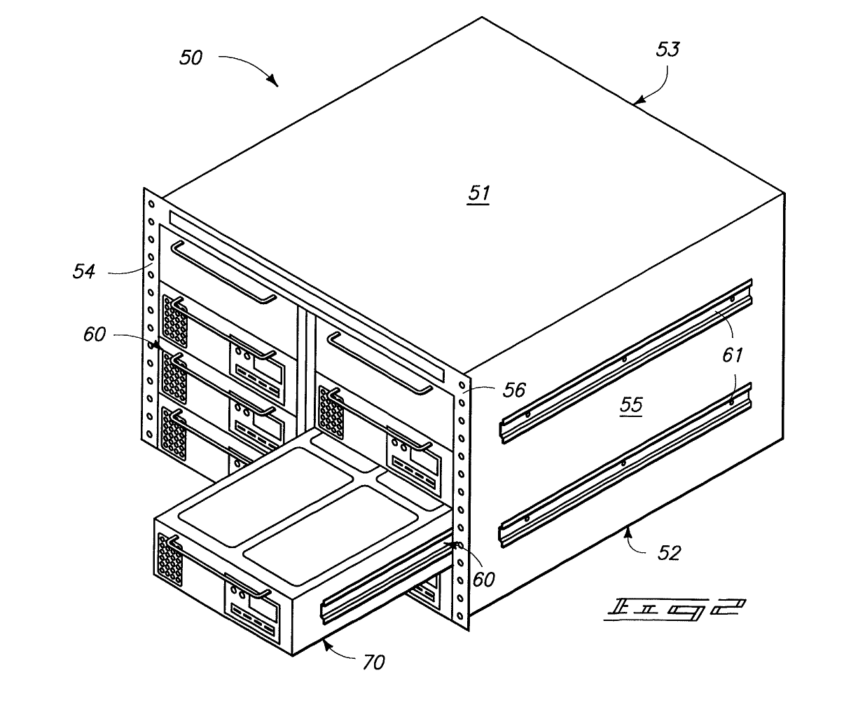

FIG. 2 is a perspective view of the module receiving assembly employed with the present invention, and showing a portion of a fuel cell power module which is enclosed within same.

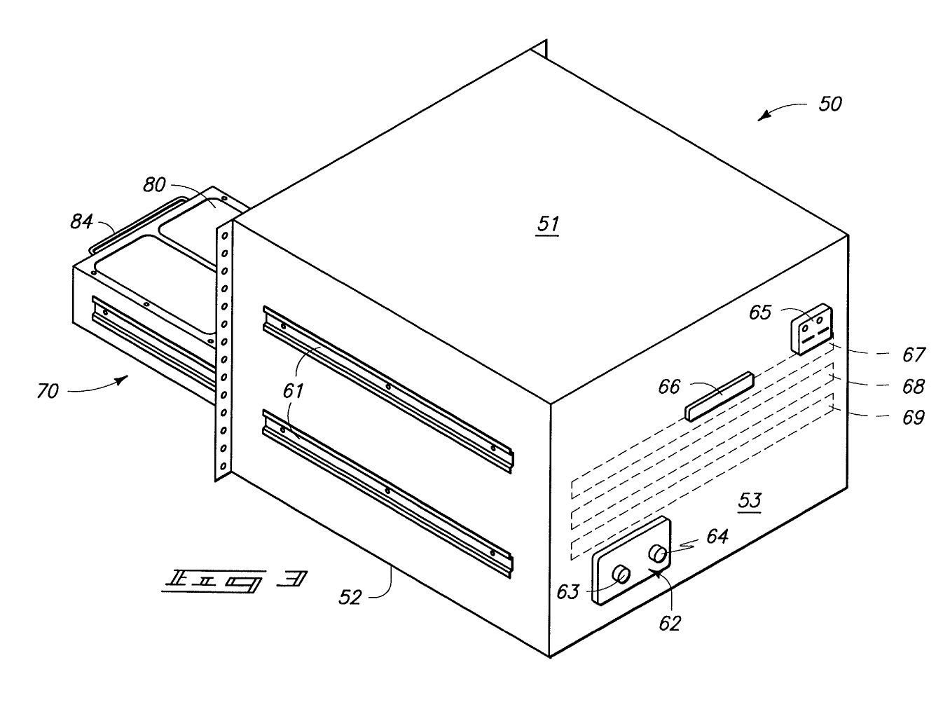

FIG. 3 is a perspective, rear elevation view of FIG. 2.

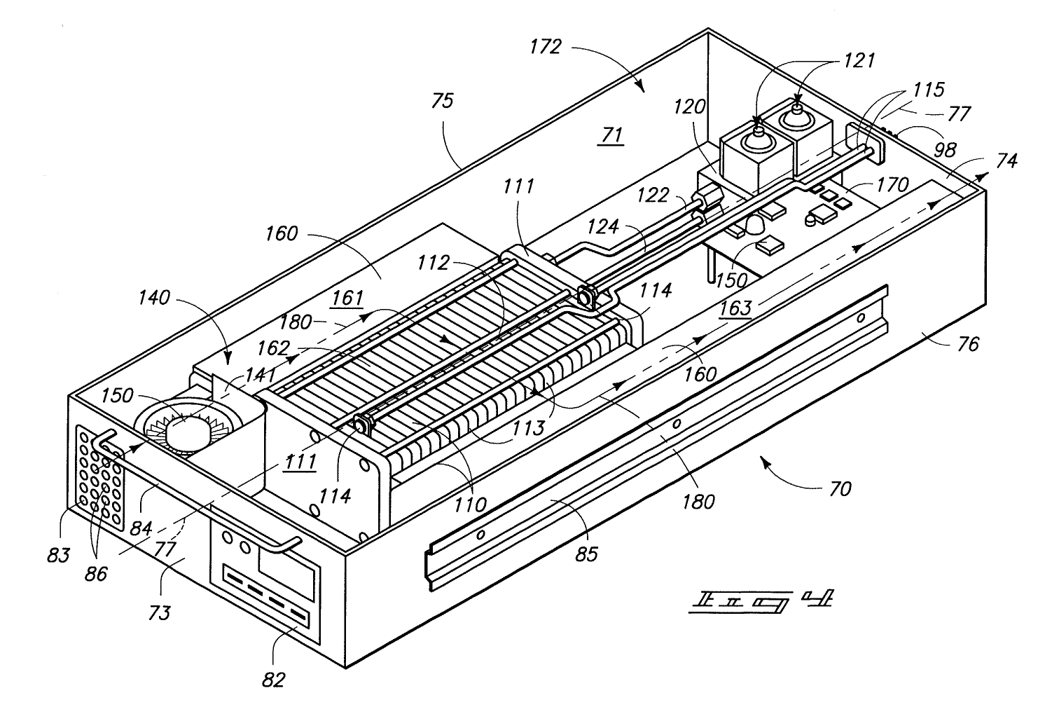

FIG. 4 is a perspective, plan view of a fuel cell power module employed in the fuel cell power system of the present invention with the top surface removed to show the structure thereunder.

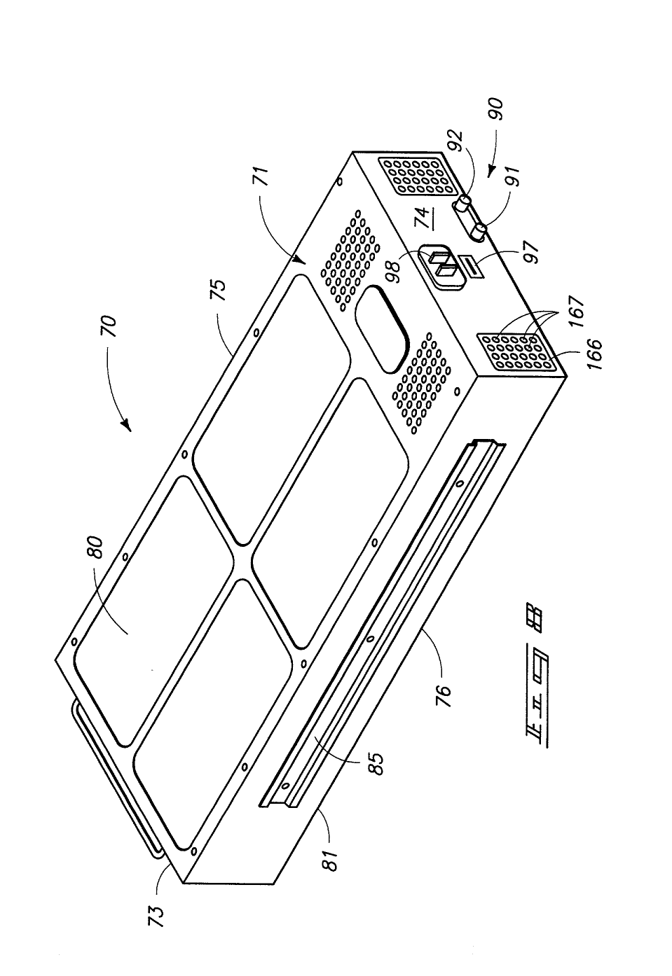

FIG. 5 is a perspective, rear elevation view of the structure shown in FIG. 4.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

The fuel cell power system is generally indicated by the numeral 10 in FIG. 1. As shown therein, the fuel cell power system 10 includes an enclosure or housing which is generally indicated by the numeral 11. The enclosure is defined by a top surface 12; bottom surface 13; opposite side walls 14; a rear wall 15; and a front wall 16, all of which defines a generally rigid enclosure. An internal cavity 20 is defined by the surfaces or walls 12-16, respectively. As seen in FIG. 1, a pair of subrack apertures 21 are formed in, and are defined by the front wall 16, and are operable to allow the passage of the respective subracks therethrough. These subracks will be discussed in greater detail hereinafter. As seen in FIG. 1, a first pair of rails 22; and a second pair of rails 23 (shown in phantom lines); are individually mounted within the cavity 20 and are oriented in generally horizontal, spaced, parallel relation one to the other. The respective pairs of rails are operable to slidably mate, couple, or otherwise mechanically cooperate with corresponding mating rail structures which are mounted on the subrack, which will be discussed hereinafter, to permit the subrack to be slidably or moveably received through one of the apertures 21 and then located in an operable orientation within the cavity 20 of the enclosure 11.

The enclosure or housing 11 is supplied with a fuel supply which is generally indicated by the numeral 30. This fuel supply may come from numerous sources. For example, the fuel supply may comprise bottled hydrogen, or a fuel which is supplied by way of a fuel processor. The fuel may also comprise a hydrogen rich gas. For purposes of further discussion in this application however, it will be assumed that the fuel supply 30 comprises hydrogen, or a hydrogen rich gas, which may have been generated by means of a fuel processor. A fuel supply conduit 31 is coupled in fluid flowing relation relative to the fuel supply 30 and terminates inside of the enclosure 11 by way of a suitable releasably sealable fluid coupling. Similarly, a suitable oxidant supply 32 is provided, and is coupled in fluid flowing relation relative to the enclosure 11 by means of an oxidant supply conduit 33. This oxidant supply conduit similarly terminates with an appropriate releasably sealable fluid coupling. The oxidant supply 32 may constitute air; although, depending upon the type of fuel cell employed, it may also include other gasses. If air is the oxidant for the fuel cell, in one form of the invention, the oxidant supply conduit, may not be required. This will be discussed in greater detail hereinafter. As seen in FIG. 1 a data conduit 34 is provided, and which terminates in the cavity 20 of the enclosure 11. The data conduit 34 allows the transmission of electrical signals (data) to and from the apparatus 10. These electrical signals permit, in some forms of the invention, the control; and monitoring of the performance of the fuel cell power system 10. Yet further, a power conduit 35 is borne by the enclosure 11, and terminates within the cavity 20. The power cable or conduit 35 is operable to direct electrical power generated by the fuel cell power system 10 away from the enclosure 11 and to a remote location. The electrical power generated by the apparatus 10 may include D.C. power; or A.C. power, in the event that the fuel cell power system includes an inverter for converting the D.C. to A.C..

Referring now to FIG. 2 a fuel cell module receiving assembly or subrack is generally indicated by the numeral 50. As seen therein, the module receiving assembly or subrack 50 is defined by top and bottom surfaces 51 and 52; a rear surface 53; a front surface 54; and opposite sidewalls 55. An engagement flange 56 is affixed substantially along the peripheral edge of the front surface 54, and is operable to engage the front wall 16 of the enclosure 11 when the module receiving assembly or subrack 50 is fully received or seated in an operable position or orientation relative to the enclosure 11. Module apertures 60 are formed in the front surface 54, and are operable to matingly receive and allow the passage of the respective fuel cell power modules, which will be discussed hereinafter. As seen in FIG. 2, a pair of rail guides 61 are attached or mounted on each of the opposite sides 55 (only one pair shown). The respective pairs of rail guides 61 slidably and otherwise cooperatively mate with the first and second pair of rail guides 22 and 23 which are mounted in the cavity 20 of the enclosure 11, as seen in FIG. 1. In this arrangement the individual module subracks 50 can move reciprocally relative to the cavity 20 of the enclosure 11. This arrangement also allows the respective modular subracks 50 to be easily repaired, replaced, or inspected in the event of poor performance or failure, while the remaining modular subracks continue to operate.

As seen in FIG. 3, a pair of fluid couplings, which are generally indicated by the numeral 62, are mounted at predetermined locations on the rear surface 53. The respective fluid couplings 62 include a fuel coupler 63; and an oxidant coupler 64, both of which extend through the rear surface 53. The fuel and oxidant couplers 63 and 64 are coupled in releasable, fluid flowing relation relative to the respective fuel and oxidant supply lines 31 and 32 which terminate within the cavity 20 of the enclosure 11, and which were discussed above. Yet further, a power coupler 65 and a data coupler 66 are also provided. These power and data couplers similarly correspondingly releasably mate or electrically couple with the power conduit 35; and the data conduit 34, both of which terminate within the cavity 20 of the enclosure 11. As seen in FIG. 3, in phantom lines, a D.C. Bus 67 is provided and which is mounted internally of the subrack 50. Yet further a fuel/oxidant manifold 68 is also provided and is mounted in spaced, relation relative to the D.C. Bus 67. A data bus 69 is also mounted internally of the subrack 50 for the purposes which will be discussed below. As will be appreciated from a study of FIG. 3, the individual fuel cell modular subracks 50 can be easily and rapidly detached and removed from the enclosure 11 without need of special tools, and most importantly by hand. Yet further, and in another form of the invention, the subrack 50 may include an inverter (not shown) for converting D.C. to A.C..

Referring now to FIGS. 1 and 2, the fuel cell power system 10 of the present invention includes a plurality of fuel cell power modules 70, each enclosing a fuel cell stack, which will be discussed hereinafter, and wherein at least one of the fuel cell power modules 70 can be removed from the fuel cell power system 10, by hand, while the remaining fuel cell power modules continue to operate.

As best seen in FIGS. 4 and 5, each of the fuel cell power modules 70 comprise a module frame which is generally indicated by the numeral 71. The module frame defines an internal cavity 72 which encloses the operable components or elements which will be discussed below. The module frame 71 includes a front wall or first end 73; a rear wall or second end 74, which is spaced from the front wall 73; and opposite first and second side walls 75 and 76. Together, these walls 73, 74, 75 and 76 form a generally narrowly rectangular shape. The module frame 71 is further defined by a major axis 77 which extends between the front and rear walls 73 and 74. Of course, other enclosure shapes may be employed with equal success. The module frame 71 further has a top surface 80 and a bottom surface 81. As seen in FIG. 4 a control or status panel 82 which displays several of the operational conditions of the fuel cell power module 70 is mounted on or affixed to the front wall 73. The control or status panel may have various warning lights; alpha-numeric indicators; visually perceptible digital or analog controls of various types, and assorted switches which control or display various aspects of the operation or condition of the fuel cell power module 70. Still further, and as seen in FIG. 4 an air passageway or cooling fluid passageway 83 is formed through, or defined by the front wall 73. This air passageway 83 allows ambient air to pass into, and through the internal cavity 72 for the purposes which will be discussed in greater detail below. Also seen in FIG. 4, is a handle 84 which is attached to the front wall 73, and a pair of rail guides 85 which are individually mounted on the first and second sidewalls 75 and 76. It should be understood that these rail guides 85 matingly couple or mechanically cooperate with other rail guide assemblies (not shown) which are mounted internally of the fuel cell module subrack 50. Such can be understood from a study of FIG. 2. As will be appreciated, the pair of rail guides 85 permit the fuel cell power module 70 to be easily removed, by hand, from the subrack 50 for purposes of maintenance, repair, or replacement depending upon the operational needs or conditions.

Referring now to FIG. 5, it will be seen that a plurality of fluid couplers 90 are mounted on the rear wall 74 of the module frame 71. In this regard the respective fluid couplers 90 include a fuel or hydrogen feed or delivery coupler 91, and an air or oxidant feed or delivery coupler 92. Yet further, the rear wall 74 further includes a releasably engageable data coupler 97, and a releasably engageable electrical coupler 98. It should be understood that the respective fluid couplers 90 appropriately mate or otherwise cooperate with the fuel/oxidant manifold 68 such that they are disposed in fluid flowing relation relative thereto. Similarly, the D.C. electrical bus 67 electrically couples with the electrical coupler 98. Yet further, the data coupler 97 releasably electrically couples in signal transmitting and receiving relation relative to the data bus 69.

Referring again to FIG. 4, the fuel cell power module 70 further includes a fuel cell stack which is generally indicated by the numeral 110. The fuel cell stack 110 is received in the internal cavity 72, and is operable to produce electricity when supplied with a suitable fuel 30 and an oxidant 32 as described above. The fuel cell stack 110 is electrically coupled to the controller or electronic control assembly which will be described in detail below.

As seen in FIG. 4, the fuel cell stack 110 is of a traditional design, that is, it has opposite end plates which are generally indicated by the numeral 111, and which are pulled or urged, one towards the other, by a plurality of tie bolts which are generally indicated by the numeral 112. The respective tie bolts place a plurality of proton exchange fuel cell membranes 113, and other assemblies, such as bipolar plates (not shown), into compression, such that a pair of spaced current collectors 114 may receive and collect the electrical current that is generated by each of the fuel cell membranes 113. Yet further, the fuel cell stack may have a monopolar structure which employs fuel cell membranes that are fabricated in a strip cell arrangement. As seen in FIG. 4, a pair of electrical conduits 115 respectively electrically connect or couple the individual current collectors 114 with the electrical coupler 98.

As seen further in FIGS. 4 and 5, a fuel/air or oxidant delivery and bleed manifold 120 is mounted within the internal cavity 72 of the module frame 71. The fuel/air or oxidant delivery and bleed manifold 120 is coupled in fluid flowing relation with the respective fluid couplers 91 and 92. The fuel/air delivery and bleed manifold 120 also includes a pair of adjustable valve or metering assemblies 121 which operate to selectively meter the fuel 30 and the oxidant 31 which is delivered respectively by way of the fuel delivery conduit 124, and the oxidant delivery conduit 122. The fuel and oxidant delivery conduits 124 and 122 are coupled in fluid flowing relation with the respective fuel coupler 91 and oxidant coupler 92 which are mounted on the rear wall 74.

As should be understood from the drawings, the oxidant delivery conduit 122 couples the fuel cell stack 110 in fluid flowing relation with a suitable oxidant supply 32 such as air or oxygen, and the fuel delivery conduit 124 couples the fuel cell stack in fluid flowing relation relative to a suitable fuel supply which may comprise a source of hydrogen 30 or a hydrogen rich gas, as earlier discussed. This is of course, providing that the fuel cell stack 110 takes on the form of a proton exchange membrane fuel cell stack.

Again referring to FIG. 4, the fuel cell power module 70 includes a cooling assembly generally indicated by the numeral 140. The cooling assembly 140 facilitates the dissipation of heat energy generated while the fuel cell stack 110 is operational. As shown in FIG. 4, the cooling assembly 140 is borne by the module frame 71, and directs a flow of air from ambient, through the fuel cell stack 110, and back to ambient. The components of the cooling system will be described in greater detail hereinafter.

As shown in FIG. 4, an air passageway 83 is formed through the front wall 73 of the module frame 71. The air passageway is made up of a plurality of apertures 86. These apertures 86 facilitate the coupling of the air passage 83 to ambient, and facilitates movement of air from ambient into a fan compartment 141 which is positioned within the internal cavity 72, and near the front wall 73 of the module frame 71.

Still referring to FIG. 4, a compressor or fan is 150 is mounted within the fan compartment 141 and is oriented in air moving relation relative to the air passageway 83. The fan 150 is electrically coupled with, and controlled by, an electronic control assembly which will be discussed in greater detail below.

The cooling assembly 140 also includes an air passageway, or air plenum, or cooling fluid path 160 which extends substantially between the front and rear walls 73 and 74 of the module frame 71. The air plenum 160 includes three major portions. The first portion 161 of the air plenum is coupled in fluid receiving relation relative to the air passageway 83 and to the fan compartment 151. As shown in the drawings, the first portion 161 of the air plenum is positioned within the internal cavity 72 of the module frame 71, and is oriented in substantially parallel relation relative to the first side wall 75 as shown in FIG. 4. Once ambient air has entered the fan compartment 141 through the air passageway 83, the fan 150 operates to move the air along the air plenum 160.

The second portion 162 of the air plenum is coupled in downstream relation relative to the first portion 161. The second portion is positioned within the internal cavity 72, and extends substantially between the opposite first and second sidewalls 75 and 76 of the module frame 71. The second portion directs the flow of ambient air through the fuel cell stack 110, and in a direction which is generally normal to the longitudinal axis 77.

The third portion 163 of the air plenum is to coupled in fluid flowing relation to and downstream of the second portion 162. The third portion is positioned within the internal cavity 72, and extends in a direction which is substantially parallel to the second side wall 76. The third portion is coupled in fluid flowing relation relative to the rear air passageway 166. As best seen in FIG. 5, the rear air passageway 166 is formed through the rear wall 74 of the module frame 71. A plurality of apertures 167 are formed in the rear wall 74 and make up the rear air passageway. The air plenum a 160 therefore directs the flow of air in a substantially ogee or “S” shaped path of travel 180. Further, the air plenum 160 has a variable diameter, and variations in the diameter of the air plenum 160 cause the velocity and pressure of the air or cooling fluid to vary as it flows through the air plenum 160.

Although the course or path of the air plenum described above is utilized in the preferred embodiment, a variety of other courses or paths of travel which direct a flow of air from ambient through the fuel cell stack, and which return the air to ambient are comprehended by this invention. In other embodiments, the course or path of the air plenum may not necessarily extend substantially between the front and rear walls 73 and 74 of the module frame 71. For example, in one embodiment the module frame 71 has opposite first and second sidewalls 75 and 76, and the cooling assembly includes an air plenum or cooling fluid path which extends substantially between the first and second sidewalls 75 and 76 and is coupled in fluid flowing relation to ambient. In yet another embodiment, the module frame 71 has opposite top and bottom surfaces 80 and 81, and the cooling assembly includes an air plenum or cooling fluid path which extends substantially between the top and bottom surfaces 80 and 81 and is coupled in fluid flowing relation to ambient.

As described above, and in the preferred embodiment, a compressor or fan 150 is mounted on the module frame 71 within the internal cavity 72, and is in air moving relation to the air passageway 83. However, it should be recognized that the compressor or fan 150 may be located remotely relative to the fuel cell power module 70. For example, the compressor or fan 150 may be located on the module frame 71 but outside of the internal cavity 72; on the fuel cell module subrack 50; or on the enclosure 11; or in other remote locations, so long as the fan 150 is in air moving relation relative to the fuel cell stack 110. Additionally, it should be recognized that other means for facilitating the movement of air or cooling fluid may also be utilized.

In other embodiments, the cooling assembly may create a pressure gradient across the fuel cell stack to facilitate the movement of air from ambient, through the fuel cell stack, and back to ambient. In yet another embodiment, the cooling assembly may create a temperature gradient across the fuel cell stack which facilitates the movement of air from ambient, through the fuel cell stack, and back to ambient.

Referring once again to FIG. 4, the operation of the fan 150 will be described in greater detail. As described above, the fan 150 is operably coupled to the air plenum 160, and facilitates the movement of air from ambient, along the air plenum 160, through the fuel cell stack 110, and back to ambient. The fan 150 is operable to move a substantially steady supply of ambient air through the air plenum 160 for purposes of eliminating heat energy generated by the fuel cell power module 70. The fan 150 is also electrically coupled to the electronic control assembly 170 which is operable to energize and de-energize the fan in order to maintain the fuel cell stack 110 within a given operational temperature range. The electronic control assembly is discussed in greater detail hereinafter.

The electronic control assembly is indicated by the numeral 170 in FIG. 4. The electronic control assembly is electrically coupled with the data coupler 97, and is mounted in spaced relation relative to the bottom surface 81 as shown. The electronic control assembly 170 is electrically coupled to the fuel cell stack 110, and is further electrically coupled to the control or status display panel 82 which shows the current operational state of the fuel cell power module 70. It should be recognized that the electronic control assembly 170 may be located remotely relative to the fuel cell power module 70. For example, it may be located on the fuel cell subrack 50; the enclosure 11; or at a distant location away from the fuel cell power system 10.

It should also be understood that the fan or compressor 150 is selectively energized by the electric control assembly such that heat energy generated by the fuel cell stack 110, during operation, and which is captured within the internal cavity 72, may be exhausted to ambient. Additionally, it should be understood that the individual fuel cell power modules may also enclose an inverter (not shown) for converting D.C. to A.C. or D.C. to D.C..

Operation

The operation of the described embodiments of the present invention are believed to be readily apparent and are briefly summarized at this point.

A fuel cell power system of the present invention is generally indicated by the numeral 10 and is shown in FIGS. 1, 2 and 3 respectively. The fuel cell power system 10 includes a plurality of fuel cell power modules 70, each enclosing a fuel cell stack 110, and a cooling assembly 140; and wherein at least one of the fuel cell power modules 70, can be removed from the fuel cell power system, by hand, while the remaining fuel cell power modules continue to operate.

Still further, the fuel cell power system 10 of the present invention includes an enclosure 11 defining a space or cavity 20. A fuel cell module receiving assembly or subrack 50 is moveably mounted on the enclosure and operable to be received in the internal space or cavity 20 of the enclosure. A plurality of fuel cell power modules 70 each including a fuel cell stack 110 operably mate with the module receiving assembly 50, and can be removed from the module receiving assembly 50 while the remaining fuel cell power modules 70 continue to operate.

In addition to the foregoing a fuel cell power system 10 is disclosed, which includes a module receiving assembly 50; a module frame 71 having an internal cavity 72, and which slideably matingly cooperates both electrically and in fluid flowing relation with the module receiving assembly 50; a fuel cell stack 110 mounted in the internal cavity 72; a controller 170 which is electrically coupled to the fuel cell stack; and a cooling assembly 140 borne by the module frame 71, and which directs a flow of air from ambient through the fuel cell stack 110, and which returns the air to ambient to facilitate the dissipation of heat generated while the fuel cell stack 110 is operational.

In a preferred embodiment, the module frame 71 has opposite front and rear walls 73 and 74 and is defined by a major axis 77 which extends between the opposite front and rear walls, and the cooling assembly 140 includes an air plenum 160 which is coupled in fluid flowing relation to ambient, and which extends substantially between the front and rear walls 73 and 74 of the module frame 71. The air plenum 160 directs the air to flow in a substantially ogee shaped path of travel 180. Further, the air plenum 160 has a variable diameter, and variations in the diameter of the air plenum 160 cause the velocity and pressure of the air to vary as it flows through the air plenum 160.

As described above, in one embodiment, the module frame 71 has opposite first and second sidewalls 75 and 76, and the cooling assembly 140 includes an air plenum which extends substantially between the first and second sidewalls 75 and 76 of the module frame 71, and wherein the air plenum is coupled in fluid flowing relation to ambient. In yet another embodiment, the module frame 71 has opposite top and bottom surfaces 80 and 81, and wherein the cooling assembly 140 includes an air plenum which extends substantially between the top and bottom surfaces 80 and 81 of the module frame 71, and wherein the air plenum is coupled in fluid flowing relation to ambient.

As disclosed above, the cooling assembly 140 includes a fan 150 which facilitates the movement of air from ambient, through the fuel cell stack 110, and back to ambient. Further, the cooling assembly 140 includes at least one fan 150 mounted in the internal cavity 72 of the module frame 71, and which facilitates the movement of the air from ambient, through the fuel cell stack 110, and back to ambient. Yet further the cooling assembly 140 includes at least one fan 150 operably coupled to the air plenum 160, and which facilitates the movement of the air from ambient, along the air plenum 160, through the fuel cell stack 110, and back to ambient. As disclosed above, the cooling assembly 140 may create a pressure gradient across the fuel cell stack 110 to facilitate the movement of the air from ambient, through the fuel cell stack 110, and back to ambient. Further, the cooling assembly 140 may create a temperature gradient across the fuel cell stack 110 to facilitate the movement of the air from ambient, through the fuel cell stack 110, and back to ambient.

In addition to the foregoing a fuel cell power system 10 is disclosed, which includes a module receiving assembly 50; a module frame 71 having opposite front and rear walls 73 and 74 which define in part an internal cavity 72, and which is further defined by a major axis 77 extending between the opposite front and rear walls 73 and 74, and which slideably matingly cooperates both electrically and in fluid flowing relation with the module receiving assembly 50; a fuel cell stack 110 mounted in the internal cavity 72; a controller 170 which is electrically coupled to the fuel cell stack; and a cooling assembly 140 borne by the module frame 71 and coupled to the controller 160, and which dissipates heat energy generated by the fuel cell stack 110 while it is in operation; and wherein the cooling assembly 140 further includes an air plenum 160 which extends substantially between, the front and rear walls 73 and 74, and which is coupled in fluid flowing relation to ambient, and which directs a flow of air from ambient, along the air plenum 160, through the fuel cell stack 110, and back to ambient, and a fan 150 mounted in the internal cavity 72 of the module frame 71, and which is operably coupled to the air plenum to facilitate movement of the air along the air plenum 160. Further, the air plenum 160 includes a first portion 161 disposed in laterally offset, substantially parallel relation relative to the major axis 77, and which directs the flow of air from ambient into the internal cavity 72; a second portion 162 of the air plenum 160 coupled in fluid flowing relation to, and downstream of, the first portion 161, and which further directs the flow of air generally transversely or perpendicular to the major axis 77 and through the fuel cell stack 110; and a third portion 163 of the air plenum 160 disposed in laterally offset substantially parallel relation relative to the major axis 77, and which is coupled in fluid flowing relation to, and downstream of, the second portion 162, and which further directs the flow of air back to ambient. Still further, the fan 150 is mounted near the first end 73 of the module frame 71 and is operably coupled with the first portion 161 of the air plenum 160, and wherein the fan 150 facilitates the movement of the air from ambient into the first portion 161 of the air plenum 160.

In addition to the foregoing a fuel cell power system 10 is disclosed, which includes a module receiving assembly 50; a module frame 71 defining an internal cavity 72, and which has opposite first and second ends 73 and 74, and which slideably matingly cooperates both electrically and in fluid flowing relation with the module receiving assembly 50; a fuel cell stack 110 mounted in the internal cavity 72; a controller 170 which is electrically coupled to the fuel cell stack; and a cooling assembly 140 which directs a flow of cooling fluid along a substantially non-linear path of travel 180 between the first and second ends 73 and 74 of the module frame 71, and through the fuel cell stack 110 to dissipate heat energy generated by the fuel cell in operation. Further, the fuel cell power module 70 has a major axis 77 which extends between the opposite first and second ends 73 and 74, and wherein the cooling assembly 140 further includes a cooling fluid path which directs the flow of cooling fluid. Yet further, the cooling fluid path includes a first portion 161 disposed in laterally offset substantially parallel relation relative to the major axis, and which directs the flow of cooling fluid into the internal cavity 72; a second portion 162 of the cooling fluid path 160 coupled in fluid flowing relation to the first portion 161, and which further directs the flow of the cooling fluid generally transversely relative to the major axis 77 and through the fuel cell stack 110; and a third portion 163 of the cooling fluid path 160 disposed in laterally offset substantially parallel relation relative to the major axis, and which is coupled in fluid flowing relation to the second portion 162, and which further directs the flow of cooling fluid out of the internal cavity 72.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A fuel cell power system, comprising:
a module receiving assembly;
a module frame having an internal cavity, and which slideably matingly cooperates both electrically and in fluid flowing relation with the module receiving assembly;
a fuel cell stack mounted in the internal cavity;
a controller which is electrically coupled to the fuel cell stack; and
a cooling assembly borne by the module frame, and which directs a flow of air from ambient through the fuel cell stack, and which returns the air to ambient to facilitate the dissipation of heat generated while the fuel cell stack is operational.

2. The fuel cell power system as claimed in claim 1, wherein the cooling assembly further comprises at least one fan which facilitates the movement of the air from ambient, through the fuel cell stack, and back to ambient.

3. The fuel cell power system as claimed in claim 1, wherein the cooling assembly further comprises at least one fan mounted in the internal cavity of the module frame, and which facilitates the movement of the air from ambient, through the fuel cell stack, and back to ambient.

4. The fuel cell power system as claimed in claim 1, wherein the cooling assembly creates a pressure gradient across the fuel cell stack which facilitates the movement of the air from ambient, through the fuel cell stack, and back to ambient.

5. The fuel cell power system as claimed in claim 1, wherein the cooling assembly creates a temperature gradient across the fuel cell stack which facilitates the movement of the air from ambient, through the fuel cell stack, and back to ambient.

6. The fuel cell power system as claimed in claim 1, wherein the module frame has opposite front and rear walls and is defined by a major axis which extends between the opposite front and rear walls, and wherein the cooling assembly further comprises an air plenum which is coupled in fluid flowing relation to ambient, and which extends substantially between the front and rear walls of the module frame.

7. The fuel cell power system as claimed in claim 6, wherein the cooling assembly further comprises at least one fan operably coupled to the air plenum, and which facilitates the movement of the air from ambient, along the air plenum, through the fuel cell stack, and back to ambient.

8. The fuel cell power system as claimed in claim 6, wherein the cooling assembly further comprises at least one fan mounted in the internal cavity of the module frame and operably coupled to the air plenum, and which facilitates the movement of the air from ambient, along the air plenum, through the fuel cell stack, and back to ambient.

9. The fuel cell power system as claimed in claim 6, wherein the air plenum directs the air to flow in a substantially ogee shaped path of travel.

10. The fuel cell power system as claimed in claim 6, wherein the air plenum has a variable diameter, and wherein variations in the diameter of the air plenum cause the velocity and pressure of the air to vary as it flows through the air plenum.

11. The fuel cell power system as claimed in claim 1, wherein the module frame has opposite first and second sidewalls, and wherein the cooling assembly further comprises an air plenum which extends substantially between the first and second sidewalls of the module frame, and wherein the air plenum is coupled in fluid flowing relation to ambient.

12. The fuel cell power system as claimed in claim 11, wherein the cooling assembly further comprises at least one fan operably coupled to the air plenum, and which facilitates the movement of the air from ambient, along the air plenum, through the fuel cell stack, and back to ambient.

13. The fuel cell power system as claimed in claim 11, wherein the cooling assembly further comprises at least one fan mounted in the internal cavity of the module frame, and which is operably coupled to the air plenum to facilitate the movement of the air from ambient, along the air plenum, through the fuel cell stack, and back to ambient.

14. The fuel cell power system as claimed in claim 1, wherein the module frame has opposite top and bottom surfaces, and wherein the cooling assembly further comprises an air plenum which extends substantially between the top and bottom surfaces of the module frame, and wherein the air plenum is coupled in fluid flowing relation to ambient.

15. The fuel cell power system as claimed in claim 14, wherein the cooling assembly further comprises at least one fan operably coupled to the air plenum, and which facilitates the movement of the air from ambient, along the air plenum, through the fuel cell stack, and back to ambient.

16. The fuel cell power system as claimed in claim 14, wherein the cooling assembly further comprises at least one fan mounted in the internal cavity of the module frame and operably coupled to the air plenum, and which facilitates the movement of air from ambient, along the air plenum, through the fuel cell stack, and back to ambient.

17. A fuel cell power system, comprising:
a module receiving assembly;
a module frame having opposite front and rear walls which define in part an internal cavity, and which is further defined by a major axis extending between the opposite front and rearwalls, and which slideably matingly cooperates both electrically and in fluid flowing relation with the module receiving assembly;
a fuel cell stack mounted in the internal cavity;
a controller which is electrically coupled to the fuel cell stack; and
a cooling assembly borne by the module frame and coupled to the controller, and which dissipates heat energy generated by the fuel cell stack while it is in operation; and wherein the cooling assembly further includes an air plenum which extends substantially between, the front and rear walls, and which is coupled in fluid flowing relation to ambient, and which directs a flow of air from ambient, along the air plenum, through the fuel cell stack, and back to ambient, and a fan mounted in the internal cavity of the module frame, and which is operably coupled to the air plenum to facilitate movement of the air along the air plenum.

18. The fuel cell power system as claimed in claim 17, wherein the air plenum further comprises:
a first portion disposed in laterally offset substantially parallel relation relative to the major axis, and which directs the flow of air from ambient into the internal cavity;
a second portion of the air plenum coupled in fluid flowing relation to the first portion, and which further directs the flow of air generally transversely across the major axis and through the fuel cell stack; and
a third portion of the air plenum disposed in laterally offset, substantially parallel relation, relative to the major axis, and which is coupled in fluid flowing relation to the second portion, and which further directs the flow of air back to ambient.

19. The fuel cell power system as claimed in claim 18, wherein the air plenum directs the air to flow in a substantially ogee shaped path of travel.

20. The fuel cell power system as claimed in claim 19, wherein the air plenum has a variable diameter, and wherein variations in the diameter of the air plenum cause the velocity and pressure of the air flowing through the air plenum to vary.

21. The fuel cell power system as claimed in claim 18, wherein the fan is mounted near the first end of the module frame and is operably coupled with the first portion of the air plenum, and wherein the fan facilitates the movement of the air from ambient into the first portion of the air plenum.

22. A fuel cell power system, comprising:
a module receiving assembly;
a module frame defining an internal cavity, and which has opposite first and second ends, and which slideably matingly cooperates both electrically and in fluid flowing relation with the module receiving assembly;
a fuel cell stack mounted in the internal cavity;
a controller which is electrically coupled to the fuel cell stack; and
a cooling assembly which directs a flow of cooling fluid along a substantially non-linear path of travel between the first and second ends of the module frame, and through the fuel cell stack to dissipate heat energy generated by the fuel cell in operation.

23. The fuel cell power system as claimed in claim 22, wherein a major axis extends between the opposite first and second ends of the module frame, and wherein the cooling assembly includes a cooling fluid path which directs the flow of cooling fluid.

24. The fuel cell power system as claimed in claim 23, wherein the cooling fluid path directs the cooling fluid to flow in a substantially ogee shaped path of travel.

25. The fuel cell power system as claimed in claim 23, wherein the cooling fluid path further comprises:
a first portion disposed in laterally offset substantially parallel relation relative to the major axis, and which directs the flow of cooling fluid into the internal cavity;
a second portion of the cooling fluid path coupled in fluid flowing relation to the first portion, and which further directs the flow of the cooling fluid generally transversely relative to the major axis and through the fuel cell stack; and
a third portion of the cooling fluid path disposed in laterally offset, substantially parallel relation, relative to the major axis, and which is coupled in fluid flowing relation to the second portion, and which further directs the flow of cooling fluid out of the internal cavity.
